(19) United States
(12) Patent Application Publication
(10) Pub. No.: US 2020/0036067 A1
(43) Pub. Date: Jan. 30, 2020

(54) BATTERY MODULE AND METHOD OF FORMING A BATTERY MODULE HOUSING

(71) Applicant: GM Global Technology Operations LLC, Detroit, MI (US)

(72) Inventors: Mahesh A. Mummigatti, Nimbekaipura (IN); Tejas R. Bhavsar, Troy, MI (US); Nagaraj Angadi, Hulimavu (IN)

(73) Assignee: GM Global Technology Operations LLC, Detroit, MI (US)

(21) Appl. No.: 16/046,135

(22) Filed: Jul. 26, 2018

(51) Int. Cl. H01M 10/6568; H01M 2/10; H01M 10/613; H01M 10/625; H01M 10/6556

(52) U.S. Cl. CPC H01M 10/6568; H01M 2/1077; B60K 6/28; H01M 10/625; H01M 10/6556; H01M 10/613

(57) ABSTRACT

A battery module includes a plurality of battery cells and a battery module 4 housing configured to at least partially enclose the plurality of battery cells. The battery module housing includes at least one wall defining an outer periphery and an opposing inner periphery. A fluid interchange system includes one or more channels formed in and extending at least partially through the at least one wall, at least one inlet portion defined in and extending at least partially through the at least one wall, and at least one outlet portion defined in and extending at least partially through the at least one wall. A coolant is introduced to the fluid interchange system through the at least one inlet portion, circulated through the one or more channels and exits the fluid interchange system through the at least one outlet portion to cool the plurality of battery cells in the battery module housing.

### INTRODUCTION

The present disclosure relates generally to a battery module and a method of forming a battery module housing. More specifically, the disclosure relates to a battery assembly having one or more battery modules with housings configured to improve battery cell cooling. Electrochemical battery cells and battery packs are used for powering torque-generating electric machines, accessory modules, or other electrical loads aboard various systems. A typical battery pack includes multiple rechargeable battery cells.

The use of electric vehicles and hybrid vehicles, such as battery electric vehicles, range extended electric vehicles, hybrid electric vehicles, plug-in hybrid electric vehicles and fuel cell hybrid electric vehicles, requiring a rechargeable energy storage source has increased over the last few years. Many hybrid electric vehicles and electric vehicles employ a battery assembly made up of multiple lithium-ion cells as an energy storage source.

### SUMMARY

Disclosed herein is a battery module including a plurality of battery cells and a battery module housing configured to at least partially enclose the plurality of battery cells. The battery module housing includes at least one wall defining an outer periphery and an opposing inner periphery. A fluid interchange system includes one or more channels formed in and extending at least partially through the at least one wall, at least one inlet portion defined in and extending at least partially through the at least one wall, and at least one outlet portion defined in and extending at least partially through the at least one wall. A coolant is introduced to the fluid interchange system through the at least one inlet portion, circulated through the one or more channels and exits the fluid interchange system through the at least one outlet portion to cool the plurality of battery cells in the battery module housing.

The battery module housing includes a first sidewall, a second wall disposed opposite the first sidewall, a top wall extending between the first sidewall and the second sidewall and a bottom wall extending between the first sidewall and the second sidewall opposite the top wall configured to define the outer periphery and the inner periphery of the battery module housing. The outer peripheries of the first sidewall, second sidewall, top wall and bottom wall of the battery module housing form at least a first end and a second end of the battery module housing.

The battery module housing includes at least one aperture in one or more of the first end and the second end of the battery module housing, wherein the at least one apertures cooperates with the inner periphery of the battery module housing. One or more closures are applied to and at least partially enclose at least one of the first end and the second end battery module housing. The battery module includes a battery cell interface receiving and securing electrode extensions of each of the plurality of battery cells and at least one end plate securable to the battery cell interface and cooperating with and at least partially enclosing at least one of the first end and the second end battery module housing.

The one or more channels of the fluid interchange system are at least partially encapsulated in the at least one wall of the battery module housing. The one or more channels defined in the at least one wall include a first set of channels formed at least partially through and extend in a first direction in the at least one wall and a second set of channels formed at least partially through and extend in a second direction in the at least one wall.

In another embodiment, a battery module housing for a battery module receiving a plurality of battery cells includes at least one wall including a first sidewall, a second sidewall disposed opposite the first sidewall, a top wall extending between the first sidewall and the second sidewall and a bottom wall extending between the first sidewall and the second sidewall opposite the top wall. The first sidewall, second sidewall, top wall and bottom wall are configured to define the outer periphery and the inner periphery of the battery module housing.

A fluid interchange system includes one or more channels formed in and extending at least partially through at least one of the first sidewall, the second sidewall, the top wall and the bottom wall. At least one inlet portion is defined in and extends at least partially through at least one of the first sidewall, the second sidewall, the top wall and the bottom wall. At least one outlet portion is defined in and extends at least partially through the at least one wall, wherein the one or more channels.

The at least one inlet portion and the at least one outlet portion cooperate to form a fluid interchange system for the battery module housing. A coolant is introduced to the fluid interchange system through the at least one inlet portion, circulated through the one or more channels and exits the fluid interchange system through the at least one outlet portion to cool the plurality of battery cells in the battery module housing.

The outer peripheries of the first sidewall, second sidewall, top wall and bottom wall of the battery module housing form at least a first end and a second end of the battery module housing. The battery module housing includes at least one aperture in one or more of the first end and the second end of the battery module housing and cooperating with the inner periphery of the battery module housing and one or more closures applied to and at least partially enclosing at least one of the first end and the second end battery module housing.

The one or more channels of the fluid interchange system are at least partially encapsulated in the at least one wall of the battery module housing. The one or more channels defined in the at least one wall includes a first set of channels formed at least partially through and extending in a first direction in the at least one wall and a second set of channels formed at least partially through and extending in a second direction in the at least one wall.

In one aspect, the fluid interchange system includes an inlet portion defined in and extending at least partially through the top wall in fluid communication with the one or more channels and an outlet portion defined in and extending at least partially through the bottom wall in fluid communication with the one or more channels and the inlet portion. Coolant is introduced through the inlet portion, circulated through the one or more channels formed in and extending at least partially through the first sidewall, the second sidewall, the top wall and the bottom wall and exits the outlet portion to cool the plurality of battery cells in the battery module housing. At least one connecting member cooperates with and extends at least partially through one or more of the first sidewall and the second sidewall, wherein the at least one separating member incorporates a passage in fluid communication with the one or more channels in the first sidewall and the second sidewall.

In another aspect, the fluid interchange system includes a first inlet portion defined in and extending at least partially through the top wall in fluid communication with one or more channels in the top wall and a first outlet portion defined in and extending at least partially through the top wall in fluid communication with one or more channels and the first inlet portion in the top wall. A second inlet portion is defined in and extending at least partially through the bottom wall in fluid communication with one or more channels in the bottom wall, while a second outlet portion is defined in and extending at least partially through the bottom wall in fluid communication with one or more channels and the second inlet portion in bottom wall. Coolant is introduced through the first inlet portion and the second inlet portions, circulated through the one or more channels formed in and extending at least partially through the top wall and the bottom wall and exits the first outlet portion and the second outlet portion to cool the plurality of battery cells in the battery module housing.

In yet another aspect, the fluid interchange system includes a first inlet portion defined in and extending at least partially through the bottom wall in fluid communication with one or more channels in the bottom wall and a first outlet portion defined in and extending at least partially through the bottom wall in fluid communication with one or more channels and the second inlet portion in bottom wall. Coolant is introduced through the first inlet portion, circulated through the one or more channels formed in and extending at least partially through the bottom wall and exits the first outlet portion to cool the plurality of battery cells in the battery module housing.

In another embodiment of the disclosure, a method of forming a battery module housing for a battery module receiving a plurality of battery cells includes the steps of forming a battery module housing pattern, applying a refractory coating to the battery module housing pattern and applying a drying process to the refractory coating on the battery module housing pattern. The battery module housing pattern is inserted in a casting drum. Casting support material is added to the casting drum to at least partially surround and encompass the battery module housing pattern. A molten metal is applied to the battery module housing pattern.

The step of forming the battery module housing pattern further includes providing a polymeric material to form the battery module housing pattern and forming at least one wall of the battery module housing to define an inner periphery and an outer periphery of the housing. One or more cooling channels are formed at least partially through the at least one wall between the inner periphery and the outer periphery of the at least one wall. At least one inlet portion and at least one outlet portion are formed at least partially through the at least one wall between the inner periphery and the outer periphery of the at least one wall. A lost foam casting process may be used with the method above.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of an example motor vehicle using a battery assembly of the type described herein;

FIG. 2 is a schematic exploded view of a battery module in accordance with one embodiment of the disclosures;

FIG. 3 is a perspective view of the battery module housing of the incorporating a series of cooling channels in accordance with one embodiment of the disclosure;

FIG. 4 is an exploded perspective view of the battery module in accordance with the disclosure;

FIG. 5 is a side sectional view of a battery module in accordance with a first embodiment of the disclosure;

FIG. 6 is a schematic flow diagram for a method of forming a battery assembly;

FIG. 7 is a side sectional view of a battery module in accordance with a second embodiment of the disclosure;

FIG. 8 is a side sectional view of a battery module in accordance with a third embodiment of the disclosure; and

FIG. 9 is a side sectional view of a battery module in accordance with a fourth embodiment of the disclosure.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity, directional terms such as top, bottom, left, right, up, over, above, below, beneath, rear, and front, may be used with respect to the drawings. These and similar directional terms are not to be construed to limit the scope of the disclosure.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

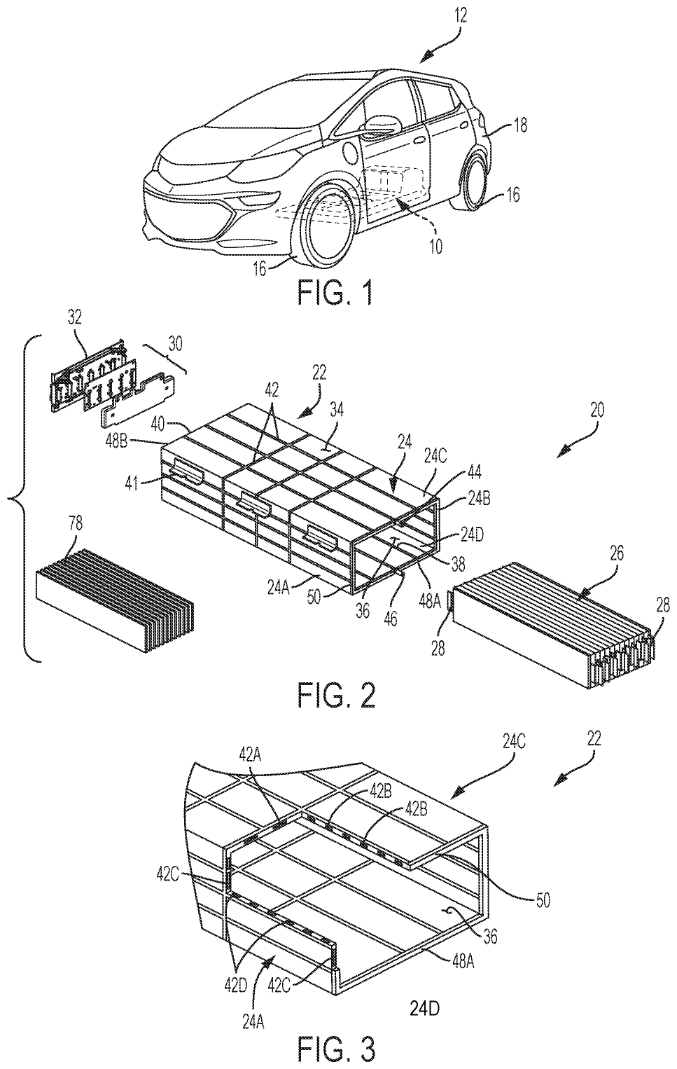

Referring to the drawings, wherein like reference numbers refer to like components, FIG. 1 is a schematic perspective view of a battery assembly 10, which may be part of a device 12. The device 12 may be a mobile platform, such as, but not limited to, a passenger car, sport utility vehicle, light truck, heavy duty vehicle, ATV, minivan, bus, transit vehicle, bicycle, robot, farm implement, sports-related equipment, boat, plane, train or other transportation device. The device 12 may also be a non-mobile platform, such as, but not limited to, a desktop computer, household appliance, medical device, home automation unit and industrial automation unit. The device 12 may take many different forms and include multiple and/or alternate components and facilities.

The battery assembly 10 is shown in FIG. 1 as part of a system of the mobile platform 12, e.g., a motor vehicle having a drive wheels 16 arranged with respect to a body 18. The battery assembly 10 electrically powers the drive wheels 16 or another load aboard the system, e.g., a generator, electric motor, auxiliary power unit, compressor, etc. The battery assembly 10 of FIG. 1 may be variously configured as a rechargeable lithium-ion or nickel-cadmium battery pack in non-limiting example embodiments. Other embodiments may be envisioned having different shapes or power ratings, or that employ other active materials, and therefore the specific configuration of FIG. 1 is exemplary and non-limiting.

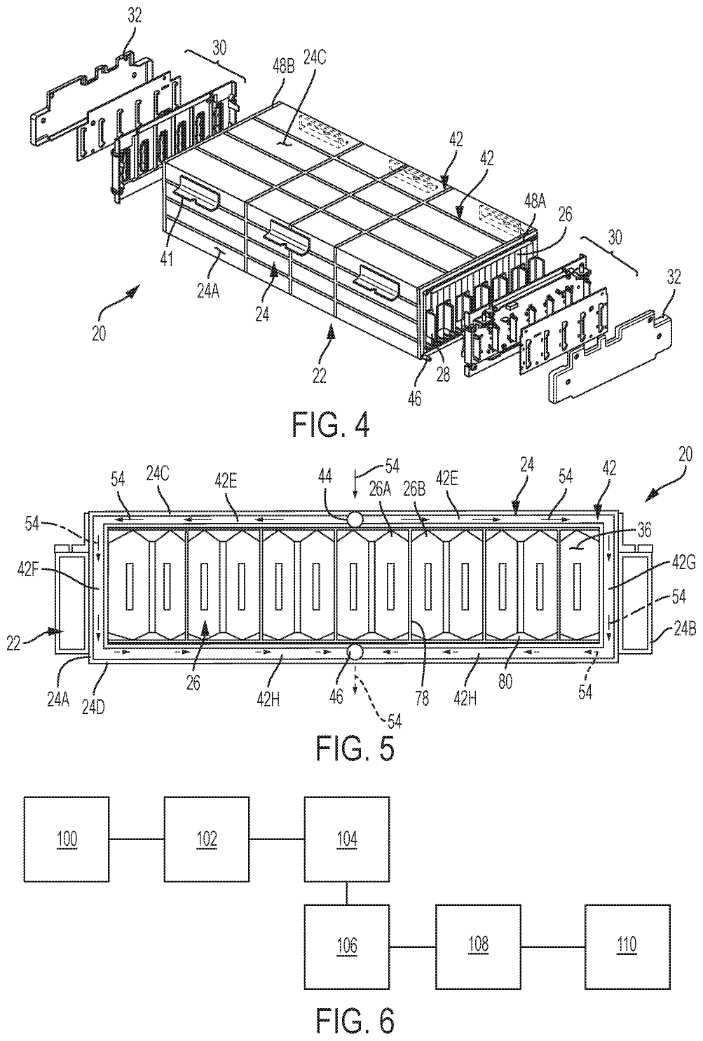

Referring now to FIGS. 2-5, the battery assembly 10 includes one or more battery modules 20. The one or more battery modules 20 each include a battery module housing 22 having at least one wall 24 configured to at least partially enclose or encapsulate a plurality of battery cells 26 therein. The battery module housing 24 may be formed from a single piece cast foam process. The plurality of battery cells 26 may be formed in a variety of configurations, including, but not limited to, a polymer-coated metal foil pouch-type battery cell or the like as is shown in FIG. 2.

Each battery cell 26 has positive (+) and negative (−) electrode extensions that may be embodied as tabular extensions 28 of the battery cell 26. A predetermined number of battery cells 26 may be arranged adjacent to each other within a battery cell interface 30. The battery cells 26 and interface 30 may be secured via at least one end plate, generally referenced by numeral 32, such that the electrode tabular extensions 28 of the various battery cells 26 are serially arranged or otherwise oriented in a desired orientation.

As used herein, the term “cell” refers to a lithium ion battery having two electrodes and capable of operating as a battery. In some situation, the term “cell” may also be used to refer to a number of cells, particularly when the cells are connected by a common positive bus structure and a common negative bus structure, in parallel. In such a situation, multiple cells may be assembled, in series or parallel, to form a battery module. Therefore, in some situations, the term cell may be used as either an equivalent to the use of a cell, herein, or as an intermediate unit between cell and module. However, as used herein, the term “module” is used to refer to a plurality of operatively-connected cells, such that FIG. 2 illustrates a module by having more than one cell. Generally, the term “pack” refers to a plurality of operatively-connected modules.

The structure of battery module 20 of FIGS. 2-5 are basic illustrations, and the portion of the battery module 20 illustrated may be part of a larger module or multiple battery modules in a battery assembly. The battery cells 26 in the module 20, may be encased or encapsulated in a container, which can be a hard (e.g., metallic) case or soft pouch (e.g., multiple layers of polymer, multiple layers of metal sheet, or combinations thereof).

The battery module 20 may be embodied as part of a rechargeable energy storage system or assembly with multiple similarly-constructed battery modules 20 arranged to form a larger battery pack or assembly 10 as shown in FIG. 1. The battery assembly 10 may be a relatively high-voltage energy storage device with a number of battery modules 20 and battery cells 26 that are dependent on the amount of required electrical power. For instance, twenty-four or more individual lithium-ion battery cells 26 may be used in an example embodiment, with the battery cells 26 being collectively capable of outputting at least 18-60 kWh of energy depending on the configuration.

The at least one wall 24 of the battery module housing 22 may include a plurality of walls that are configured to cooperate to form the housing 22. For example, battery module housing 22 may include a first wall or first sidewall 24A, an opposing second wall or second sidewall 24B, a third wall or top wall 24C extending between the first wall 24A and the second wall 24B and a fourth wall or bottom wall 24D extending between the first wall 24A and the second wall 24B opposite the third wall 24C that cooperate to form the housing 22. The number of walls may be varied for a variety of geometries, including, for example, a single cylindrical wall, a pair of cooperating semi-cylindrical walls or the like. The walls 24 may be made of a metal, such as aluminum, aluminum alloy or the like or a polymer, polymer composite or other sufficiently rigid material. The battery module housing 22 may be formed as a unitary structure with walls 24A, 24B, 24C, 24D. Alternatively, the battery module housing 22 may be assembled by walls 24A, 24B, 24C, 24D or by mating upper and lower sections with walls 24A, 24B, 24C, 24D.

Each of the walls 24 include an outer periphery 34 and an opposing inner periphery 36. Walls 24A, 24B, 24C, 24D, when cooperating and configured together to form the battery module housing 22, also collectively define an outer periphery 34 and an inner periphery 36 of the of the battery module housing 22. Walls 24A, 24B, 24C, 24D, when cooperating and configured together to form the battery module housing 22 further define at least a first end 48A and an opposing second end 48B.

At least one aperture 38, 40 may be formed by and between the walls 24 in at least one of the first end 48A and second end 48B of the battery module housing 22. The at least one aperture 38, 40 may cooperate with and provide access to the inner periphery 36 of the battery module housing 22. Portions of the plurality of battery cells 26, such as the electrode tabular extensions 28, may extend at least partially through the apertures 38, 40 and engage the interface 30 and end plates 32 to allow for electrical connections. One or more flanges 41 may be provided on the outer periphery 34 of the one or more walls 24 that may support the connection of the housing 22 to a surface (not shown).

One or more channels 42 may be defined in and extend at least partially through the at least one wall 24 between the outer periphery 34 and inner periphery 36 of the at least one wall 24. The quantity and position of the one or more channels 42 in each of the walls 24 may be adjusted to accommodate a number of factors, such as, but not limited to, the size of the battery module housing 22 and the type and quantity of battery cells 26 received and supported within the inner periphery 36 of the housing 22. Further, channels 42 may be formed in each of the walls 24 in a variety of positions and configurations and may also cooperate with channels 42 in adjacent walls 24 of the battery module housing 22. Additionally, the one or more channels may be at least partially encapsulated in the at least one wall 24 or fully enclosed between the outer periphery 34 and the inner periphery 36 of the at least one wall 24.

In one exemplary embodiment shown in FIGS. 2 and 3, the battery module housing 22 is formed as a unitary structure formed by the first sidewall 24A, opposing second sidewall 24B, top wall 24C and bottom wall 24D. The one or more channels 42 defined or formed in the walls 24 may include at least a first set of channels 42A formed at least partially through and extend in a first direction in the top wall 24C and a second set of channels 42B formed at least partially through and extend in a second direction in the top wall 24C. Channels 42A and 42B may intersect or cooperate with each other to be in fluid communication as the channels 42A, 42B extend through the top wall 24C. However, channels 42A, 42B may be arranged in alternate configurations and geometries to accomplish the objectives of the disclosure.

Additionally, a first set of channels 42C may be defined or formed at least partially through and extend in a first direction in the first sidewall 24A while a second set of channels 42D may be formed at least partially through and extend in a second direction in the first sidewall 24A. As with channels 42A and 42B, channels 42C, 42D may intersect and cooperate with each other as the channels 42C, 42D extend through the wall 24B. It is further contemplated that the one or more channels 42 defined in adjacent walls 24 of the battery module housing 22, such as the second set of channels 42B in the top wall 24C and the second set of channels 42D in the first sidewall 24A, may intersect and cooperate with each other when the walls 24A, 24C form the battery module housing 22.

At least one inlet portion 44 may be defined or formed in and extend at least partially through the at least one wall 24 of the battery module housing 22. The quantity and position of the at least one inlet portion 44 in the battery module housing 22 may be adjusted to accommodate a number of factors, such as, but not limited to, the size of the battery module housing 22 and the type and quantity of battery cells 26 received and supported within the inner periphery 36 of the housing 22. For example, the at least one inlet portion 44 may be formed in and extend at least partially through one or more of the first end 48A, the second end 48B of the battery module housing 22.

Additionally, the at least one inlet portion 44 may be at least partially encapsulated in the at least one wall 24 or fully enclosed between the outer periphery 34 and the inner periphery 36 of the at least one wall 24. Further, the at least one inlet portion 44 may cooperate with and be in fluid communication with the one more channels 42 in the at least one wall 24 of the battery module housing 22. Alternatively, the at least one inlet portion 44 may cooperate with the one or more channels 42 through a connector or the like (not shown).

At least one outlet portion 46 may be defined or formed in and extend at least partially through the at least one wall 24 of the battery module housing 22. As with the at least one inlet portion 44, the quantity and position of the at least one outlet portion 46 in the battery module housing 22 may be adjusted to accommodate a number of factors, such as, but not limited to, the size of the battery module housing 22 and the type and quantity of battery cells 26 received and supported within the inner periphery 36 of the housing 22. For example, the at least one outlet portion 46 may be formed in and extend at least partially through one or more of the first end 48A, the second end 48B of the battery module housing 22.

The at least one outlet portion 46 may cooperate with and be in fluid communication with the at least one inlet portion 44 and the one more channels 42 in the at least one wall 24 of the battery module housing 22. The at least one outlet portion 46 may be at least partially encapsulated in the at least one wall 24 or fully enclosed between the outer periphery 34 and the inner periphery 36 of the at least one wall 24. Further, the at least one outlet portion 46 cooperate with the at least one inlet 44 and the one or more channels 42 through a connector or the like (not shown).

As shown in FIGS. 2 and 3, the outer peripheries 34 of the first sidewall 24A, opposing second sidewall 24B, top wall 24C and opposing bottom wall 24D of the battery module housing 22 may form at least a first end 48A and a second end 48B of the housing 22. The one or more channels 42 formed in the at least one wall 24 may extend to at least the first end 48A and the second end 48B of the housing 22.

One or more closures 50 may be applied around at least one of the first end 48A and the second end 48B of the battery housing module 22 to at least partially enclose and create a seal for a fluid interchange system 52, in the housing 22 created between the one or more channels 42, the at least one inlet portion 44 and the at least one outlet portion 46. The fluid interchange system 52 between the one or more channels 42, at least one inlet portion 44 and the at least one outlet portion 46 may be used to support to cooling of the plurality of battery cells 26 disposed within the inner periphery 36 of the battery module housing 22.

In one exemplary embodiment, a coolant or cooling fluid is introduced to the one or more channels 42 through the at least one inlet portion 44. The coolant or cooling fluid may represent a variety of fluids, including, but not limited to, a gas or liquid such as a water based coolant or dielectric oil. The coolant or cooling fluid may either be circulated through the at least one inlet portion 44 into the one or more channels 42 by a pump or other device or may be passively introduced to the one or more channels 42. The at least one outlet portion 46, in addition to a connection to a pump may also be connected to a heat exchanger or the like to recondition the cooling fluid after exiting the battery module 20.

Referring now to FIG. 6, a method of forming the battery module housing is described in greater detail. The battery module housing may be formed using a variety of manufacturing processes. In one exemplary embodiment, the battery module housing may be formed using a lost foam casting process. At block 100, the battery module housing foam pattern may be hand cut or machined from a block of polymeric material, such as polystyrene, polymethyl methacrylate (PMMA) or the like. The cutting or machining process forms the inner and outer periphery of the housing, as well as the one or more cooling channels, inlet and outlet are formed into the foam pattern.

Alternatively, the battery module housing foam pattern may be formed by injecting pre-heated beads of polystyrene into a preheated aluminum mold at low pressure. Steam is applied to the polystyrene, causing the polystyrene to expand and fill the mold. The battery module housing foam pattern creation process may be used to create a single foam pattern or to create multiple foam patterns.

It is also contemplated that the battery module housing foam pattern may be created from a single foam pattern or may be formed from mating pattern sections that are joined, adhered or fastened together. It is further contemplated that multiple battery module housing foam patterns may be placed in a cluster arrangement.

At block 102, a refractory coating may be applied to the foam pattern to prepare the foam pattern for the casting process. The refractory coating may be applied using a variety of methods, including spraying, brushing or dipping the coating on the foam pattern. The refractory coating acts a barrier between the foam pattern and the casting support materials. It is also contemplated that the refractory coating utilizes materials to allow gases created during the casting process to escape through the casting support materials.

At block 104, the foam patterns are subjected to a drying process to ensure the refractory coating dries on the foam pattern. Once dried, the coated foam patterns are inserted into a casting flask or drum at block 106. Sand or other casting support materials are added to the casting flask to surround the foam pattern or clusters of foam patterns. The casting flask may be subjected to a vibration compacting process to ensure the casting support materials surround and encompass the foam patterns. A portion of the foam patterns or the cluster connecting the foam patterns may be exposed from the casting support materials.

At block 108, molten metal, such as aluminum, an aluminum alloy or the like, may be poured on the exposed portion of the foam pattern and into the foam pattern encompassed in the casting support materials. The molten metal vaporizes the polystyrene foam pattern through pyrolysis or a thermal degradation process, wherein the foam pattern is progressively replaced by the metal. The refractory coating retains the shape of the battery module housing from the foam pattern and acts as a barrier to the casting support materials. The resultant gas from the vaporized foam pattern flows through the refractory coating and the casting support materials and out of the flask through vents. At block 110, the cast metal battery module housing is removed from the casting support materials.

Referring back to FIG. 5, a sectional view of at least one embodiment of the battery module 20 is illustrated. In this first embodiment of the battery module 20, the battery module housing 22 includes one or more channels 42 formed in each of the first sidewall 24A, opposing second sidewall 24B, connecting top wall 24C, and opposing connecting bottom wall 24D to cool the plurality of battery cells stored therein. An inlet portion 44 may be provided in top wall 24C. It is understood that the quantity and position of the at least one inlet portion 44 in the battery module housing 22 may be adjusted to accomplish the purposes of this disclosures.

One or more channels 42E extend at least partially through the top wall 24C and cooperate with the inlet portion 44. Coolant flow, generally referenced by arrows and reference numeral 54, is introduced to the one or more channels 42E through the inlet portion 44. The coolant 54 is introduced from the inlet portion 44 at a first temperature and circulates or flows through the one or more channels 42 of the fluid interchange system, generally referenced as numeral 52, to draw heat from the plurality of battery cells 26 received within the inner periphery 36 of the battery module housing 22 to cool the battery cells 26 in the battery module housing 22.

Coolant 54 flows from the inlet portion 44 through channel 42E toward channels 42F, 42G in fluid communication with channel 42E in the opposing first sidewall 24A and second sidewall 24B. As the coolant 54 circulates or flows through the one or more channels 42 of the battery module housing 22, the coolant 54 draws heat generated by the plurality of battery cells 26, thereby increasing the temperature of the coolant 54 from a first temperature as the coolant 54 is introduced to the fluid interchange system 52 at the at least one inlet portion 44 to at least a second temperature that flows toward the at least one outlet portion 46. The at least one outlet portion 46 may cooperate with the one or more channels 42H in the bottom wall 24D of the battery module housing 22, thereby allowing the coolant 54 heated to at least one second temperature to exit or be removed from the battery module housing 22.

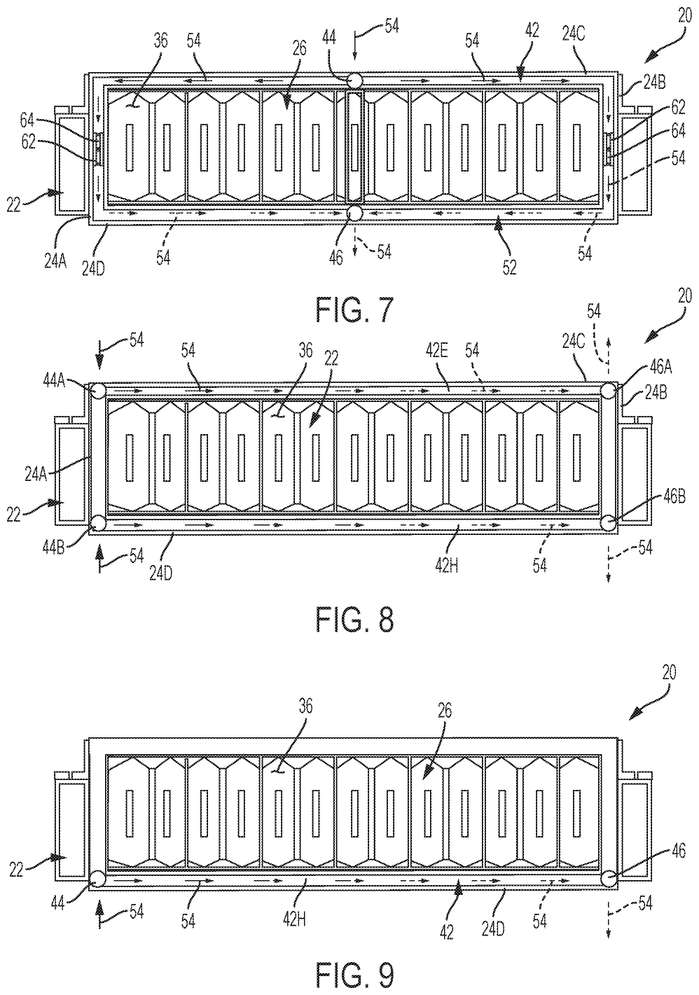

Referring now to FIG. 7, a second embodiment of the battery module 20 is illustrated. As with the first embodiment of the battery module 20 illustrated in FIG. 6, the battery module housing 22 includes a top wall 24C, an opposing bottom wall 24D, and a pair of opposing sidewalls 24A, 24B extending between and connected to the top wall 24C and bottom wall 24D. One or more channels 42 extend through each of the walls 24 and are in fluid communication with each other. The battery module housing 22 further includes at least one inlet portion 44 and at least one outlet portion 46 in fluid communication with the one or more channels 42 to form the fluid interchange system 52.

The battery module housing 22 may further include at least one connecting member 62 cooperating with and extending at least partially through one or more of the first sidewall 24A and the second sidewall 24B of the housing 22. The at least one connecting member 62 incorporates a passage 64 in fluid communication with the one or more channels 42 in the walls 24, the at least one inlet portion 44 and the at least one outlet portion 46. The one or more channels 42 in walls 24 and passage 64 in the at least one connecting member 62 direct coolant 54 flow at a first temperature from the at least one inlet portion 44, thereby drawing heat from the plurality of battery cells 26 received within the inner periphery 36 of the battery module housing 22 such that the coolant 54 at least a second temperature flows in a direction to the at least one outlet portion 46. It is contemplated that the at least one connecting member or connector 62 and passage 64 may be provided in any of the one or more walls 24.

A third embodiment of the battery module 20 is illustrated in FIG. 8. The battery module housing 22 includes a first or top wall 24C incorporating one or more channels 42E therein and an opposing bottom wall 24D incorporating one or more channels 42H. Opposing first and second sidewalls 24A, 24B extend between the top wall 24C and bottom wall 24D. A first inlet portion 44A cooperates with the top wall 24C and is in fluid communication with the one or more channels 42E, while a second inlet portion 44B cooperates with the bottom wall 24D and is in fluid communication with the one or more channels 42H.

Coolant 54 is introduced through the inlet portions 44A, 44B at a first temperature and flows through the channels 42E, 42H to cool the plurality of battery cells 26 received within the inner periphery 36 of the battery module housing 22. The coolant exits through the outlet portions 46A, 46B carrying heat generated by the battery cells 26 such that the coolant 54 is heated to at least a second temperature.

Alternatively, as is shown in FIG. 9, the battery module housing 22 of the battery module 20 may be formed to include one or more channels 42 formed in a single wall of the housing 22, such as the bottom wall 24D. Coolant 54 flows through an inlet portion 44 at a first temperature into channel 42H. The coolant 54 in channel 42H absorbs heat from the plurality of battery cells 26 in the inner periphery 36 of the housing 22. Coolant 54 carrying heat generated by the battery cells 26 such that the coolant is heated to at least a second temperature and exits the housing 22 through the outlet portion 46 in fluid communication with the channel 42H.

Referring now to FIG. 5, the battery module housing 22 may include a series of structural spacer members 78, each of which is disposed between and separates an adjacent pair of battery cells 26A and/or 26B. By separating adjacent pairs of the battery cells 26A, 26B, an impact force that has at least a component directed perpendicular to the length of the spacer members 78 (i.e., a component in a direction from one of the battery cells 26A, 26B toward another one of the battery cells 26A, 26B located on an opposite side of the interposed spacer member 78) will be at least partially absorbed by the spacer member 78. Further, a compliant supporting structure 80, such as foam or the like, may be provided in the inner periphery 36 of the battery module housing 22 between the inner periphery 36 and battery cells 26 to support and protect the battery cells 26 in the battery module housing 22.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A battery module comprising:
a plurality of battery cells; and
a battery module housing configured to at least partially enclose the plurality of battery cells, the battery module housing including:
at least one wall defining an outer periphery and an opposing inner periphery,
one or more channels formed in and extending at least partially through the at least one wall,
at least one inlet portion defined in and extending at least partially through the at least one wall, and
at least one outlet portion defined in and extending at least partially through the at least one wall, wherein the one or more channels, the at least one inlet portion and the at least one outlet portion cooperate to form a fluid interchange system for the battery module housing,
wherein a coolant is introduced to the fluid interchange system through the at least one inlet portion, circulated through the one or more channels and exits the fluid interchange system through the at least one outlet portion to cool the plurality of battery cells in the battery module housing.

2. The battery module of claim 1 wherein the battery module housing further comprises a first sidewall, a second wall disposed opposite the first sidewall, a top wall extending between the first sidewall and the second sidewall and a bottom wall extending between the first sidewall and the second sidewall opposite the top wall configured to define the outer periphery and the inner periphery of the battery module housing.

3. The battery module of claim 2 wherein the outer peripheries of the first sidewall, second sidewall, top wall and bottom wall of the battery module housing form at least a first end and a second end of the battery module housing.

4. The battery module of claim 3 further comprising at least one aperture in one or more of the first end and the second end of the battery module housing, wherein the at least one apertures cooperates with the inner periphery of the battery module housing.

5. The battery module of claim 3 further comprising one or more closures applied to and at least partially enclosing at least one of the first end and the second end battery module housing.

6. The battery module of claim 3 further comprising a battery cell interface receiving and securing electrode extensions of each of the plurality of battery cells and at least one end plate securable to the battery cell interface and cooperating with and at least partially enclosing at least one of the first end and the second end battery module housing.

7. The battery module of claim 1 wherein the one or more channels of the fluid interchange system are at least partially encapsulated in the at least one wall of the battery module housing.

8. The battery module of claim 7 wherein the one or more channels defined in the at least one wall further comprise a first set of channels formed at least partially through and extending in a first direction in the at least one wall and a second set of channels formed at least partially through and extending in a second direction in the at least one wall.

9. A battery module housing for a battery module receiving a plurality of battery cells, the battery module housing comprising:
at least one wall including a first sidewall, a second sidewall disposed opposite the first sidewall, a top wall extending between the first sidewall and the second sidewall and a bottom wall extending between the first sidewall and the second sidewall opposite the top wall, wherein the first sidewall, second sidewall, top wall and bottom wall are configured to define the outer periphery and the inner periphery of the battery module housing; and
a fluid interchange system, the fluid interchange system including:
one or more channels formed in and extending at least partially through at least one of the first sidewall, the second sidewall, the top wall and the bottom wall,
at least one inlet portion defined in and extending at least partially through at least one of the first sidewall, the second sidewall, the top wall and the bottom wall, and
at least one outlet portion defined in and extending at least partially through the at least one wall, wherein the one or more channels, the at least one inlet portion and the at least one outlet portion cooperate to form a fluid interchange system for the battery module housing,
wherein a coolant is introduced to the fluid interchange system through the at least one inlet portion, circulated through the one or more channels and exits the fluid interchange system through the at least one outlet portion to cool the plurality of battery cells in the battery module housing.

10. The battery module housing of claim 9 wherein the outer peripheries of the first sidewall, second sidewall, top wall and bottom wall of the battery module housing form at least a first end and a second end of the battery module housing.

11. The battery module housing of claim 10 further comprising:
at least one aperture in one or more of the first end and the second end of the battery module housing and cooperating with the inner periphery of the battery module housing; and
one or more closures applied to and at least partially enclosing at least one of the first end and the second end battery module housing.

12. The battery module housing of claim 9 wherein the one or more channels of the fluid interchange system are at least partially encapsulated in the at least one wall of the battery module housing.

13. The battery module housing of claim 12 wherein the one or more channels defined in the at least one wall further comprise a first set of channels formed at least partially through and extending in a first direction in the at least one wall and a second set of channels formed at least partially through and extending in a second direction in the at least one wall.

14. The battery module housing of claim 9 wherein the fluid interchange system further comprises:
an inlet portion defined in and extending at least partially through the top wall in fluid communication with the one or more channels,
an outlet portion defined in and extending at least partially through the bottom wall in fluid communication with the one or more channels and the inlet portion,
wherein coolant is introduced through the inlet portion, circulated through the one or more channels formed in and extending at least partially through the first sidewall, the second sidewall, the top wall and the bottom wall and exits the outlet portion to cool the plurality of battery cells in the battery module housing.

15. The battery module housing of claim 14 further comprising at least one connecting member cooperating with and extending at least partially through one or more of the first sidewall and the second sidewall, wherein the at least one separating member incorporates a passage in fluid communication with the one or more channels in the first sidewall and the second sidewall.

16. The battery module housing of claim 9 wherein the fluid interchange system further comprises:
a first inlet portion defined in and extending at least partially through the top wall in fluid communication with one or more channels in the top wall;
a first outlet portion defined in and extending at least partially through the top wall in fluid communication with one or more channels and the first inlet portion in the top wall;
a second inlet portion defined in and extending at least partially through the bottom wall in fluid communication with one or more channels in the bottom wall;
a second outlet portion defined in and extending at least partially through the bottom wall in fluid communication with one or more channels and the second inlet portion in bottom wall,
wherein coolant is introduced through the first inlet portion and the second inlet portions, circulated through the one or more channels formed in and extending at least partially through the top wall and the bottom wall and exits the first outlet portion and the second outlet portion to cool the plurality of battery cells in the battery module housing.

17. The battery module housing of claim 9 wherein the fluid interchange system further comprises:
a first inlet portion defined in and extending at least partially through the bottom wall in fluid communication with one or more channels in the bottom wall; and
a first outlet portion defined in and extending at least partially through the bottom wall in fluid communication with one or more channels and the second inlet portion in bottom wall,
wherein coolant is introduced through the first inlet portion, circulated through the one or more channels formed in and extending at least partially through the bottom wall and exits the first outlet portion to cool the plurality of battery cells in the battery module housing.

18. A method of forming a battery module housing for a battery module receiving a plurality of battery cells, the method comprising:
forming a battery module housing pattern;
applying a refractory coating to the battery module housing pattern;
applying a drying process to the refractory coating on the battery module housing pattern;
inserting the battery module housing pattern in a casting drum;
adding casting support material to the casting drum to at least partially surround and encompass the battery module housing pattern; and
applying a molten metal to the battery module housing pattern.

19. The method of claim 18 wherein the step of forming the battery module housing pattern further comprises:
providing a polymeric material to form the battery module housing pattern;
forming at least one wall of the battery module housing to define an inner periphery and an outer periphery of the housing;
forming one or more cooling channels at least partially through the at least one wall between the inner periphery and the outer periphery of the at least one wall;
forming at least one inlet portion at least partially through the at least one wall between the inner periphery and the outer periphery of the at least one wall; and
forming at least one outlet portion at least partially through the at least one wall between the inner periphery and the outer periphery of the at least one wall.

20. The method of claim 19 wherein the method comprises a lost foam casting process.
